(19) United States
(12) Patent Application Publication
(10) Pub. No.: US 2012/0324492 A1
(43) Pub. Date: Dec. 20, 2012

(54) VIDEO SELECTION BASED ON ENVIRONMENTAL SENSING

(75) Inventors: David Rogers Treadwell, III, Seattle, WA (US); Doug Burger, Bellevue, WA (US); Steven Bathiche, Kirkland, WA (US); Joseph H. Matthews, III, Woodinville, WA (US); Todd Eric Holmdahl, Redmond, WA (US); Jay Schiller, Medina, WA (US)

(73) Assignee: MICROSOFT CORPORATION, Redmond, WA (US)

(21) Appl. No.: 13/164,553

(22) Filed: Jun. 20, 2011

(51) Int. Cl. H04H 60/33

(52) U.S. Cl. 725/10

(57) ABSTRACT

Embodiments related to providing video items to a plurality of viewers in a video viewing environment are provided. In one embodiment, the video item is provided by determining identities for each of the viewers from data received from video viewing environment sensors, obtaining the video item based on those identities, and sending the video item for display.

### BACKGROUND

Obtaining real-time feedback for video programming may pose various challenges. For example, some past approaches utilize sample groups to provide feedback to broadcast television content. Such feedback may then be used to guide future programming decisions. However, the demographics of such sample groups may rely upon the goals of the entity that is gathering the feedback, and thus may not be helpful in making programming decisions regarding many potential viewers outside of the target demographic profile. Further, such feedback is generally used after presentation of the program for future programming development, and thus does not affect the programming currently being watched as the feedback is gathered.

### SUMMARY

Various embodiments are disclosed herein that relate to selecting video content items based upon data from video viewing environment sensors. For example, one embodiment provides a method comprising determining identities for each viewer in a video viewing environment from data received from video viewing environment sensors, obtaining a video item based on the determined identity or identities, and sending the video item to a display device for display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows viewers watching a video item within a video viewing environment according to an embodiment of the present disclosure.

FIG. 2 schematically shows the video viewing environment embodiment of FIG. 1 after the addition of a viewer and a change in video content.

FIG. 3 schematically shows the video viewing environment embodiment of FIG. 2 after another change in viewership and video content.

FIGS. 4A-D show a flow diagram depicting a method of providing video items to viewers in a video viewing environment according to an embodiment of the present disclosure.

FIG. 5 schematically shows a viewer emotional response profile and a viewing interest profile according to an embodiment of the present disclosure.

### DETAILED DESCRIPTION

Broadcast television has long been a one-way channel, pushing out programming and advertisement without providing a real-time feedback loop for viewer feedback, making content personalization difficult. Thus, the disclosed embodiments relate to entertainment systems including viewing environment sensors, such as image sensors, depth sensors, acoustic sensors, and potentially other sensors such as biometric sensors, to assist in determining viewer preferences for use in helping viewers to discover content. Such sensors may allow systems to identify individuals, detect and understand human emotional expressions, and provide real-time feedback while a viewer is watching video. Based on such feedback, an entertainment system may determine a measure of a viewer's enjoyment of the video, and provide real-time responses to the perceived viewer emotional responses, for example, to recommend similar content, record similar content playing concurrently on other channels, and/or change the content being displayed.

Detection of human emotional expressions may further be useful for learning viewer preferences and personalizing content when an entertainment system is shared by several viewers. For example, one viewer may receive sports recommendations while another may receive drama recommendations. Further, content may be selected and/or customized to match the combined interests of viewers using the display. For example, content may be customized to meet the interest of family members in a room by finding content at the intersection of viewing interests for each of those members.

Further, detecting viewer emotional feedback as the viewer views content may also allow content to be updated in real-time, for example, by condensing long movies into shorter time periods, by cutting out uninteresting scenes, by providing a different edited version of the content item, and/or by targeting advertisements to viewers more effectively.

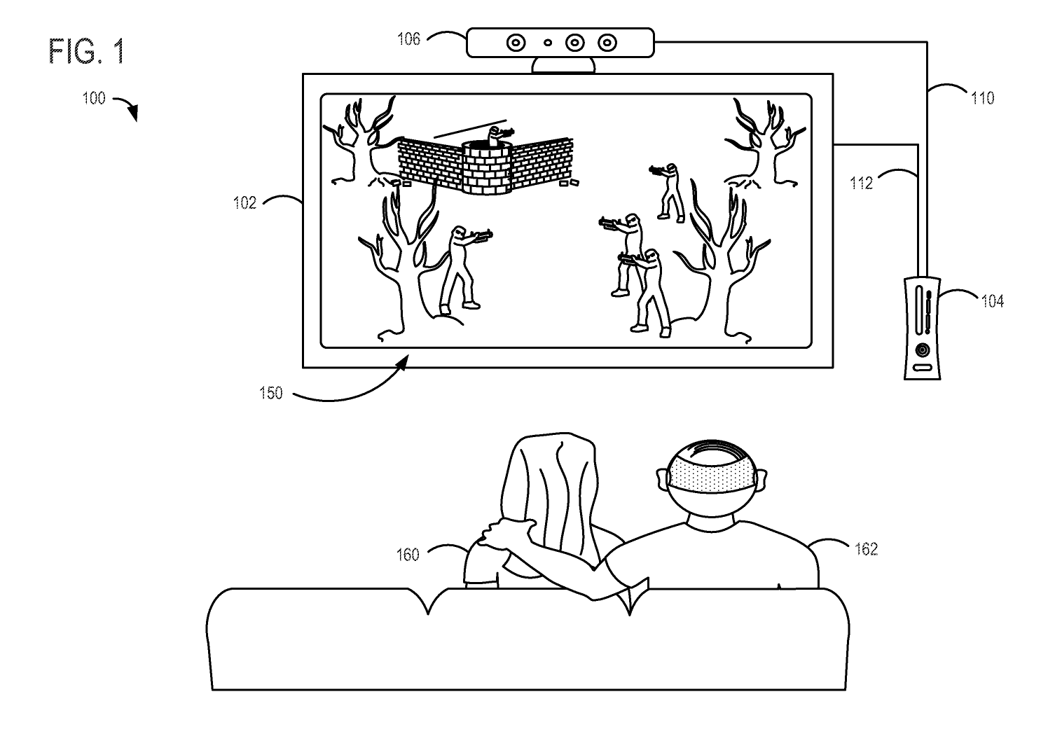

FIG. 1 schematically shows viewers 160 and 162 watching a video item 150 within a video viewing environment 100. A video viewing environment sensor system 106 connected with a media computing device 104 provides sensor data to media computing device 104 to allow media computing device 104 to detect viewer emotional responses within video viewing environment 100. Video viewing environment sensor system 106 may include any suitable sensors, including but not limited to one or more image sensors, depth sensors, and/or microphones or other acoustic sensors. Data from such sensors may be used by computing device 104 to detect postures, gestures, speech, and/or other expressions of a viewer, which may be correlated by media computing device 104 to human affect displays. It will be understood that the term “human affect displays” as used herein may represent any detectable human response to content being viewed, including but not limited to human emotional expressions and/or detectable displays of human emotional behaviors, such as facial, gestural, and vocal displays, whether performed consciously or subconsciously.

Media computing device 104 may process data received from sensor system 106 to generate temporal relationships between video items viewed by a viewer and each viewer's emotional response to the video item. As explained in more detail below, such relationships may be recorded as a viewer's emotional response profile for a particular video item and included in a viewing interest profile cataloging the viewer's video interests. This may allow the viewing interest profiles for a plurality of viewers in a viewing party to be retrieved and used to select items of potentially greater interest for viewing by the current audience.

As a more specific example, image data received from viewing environment sensor system 106 may capture conscious displays of human emotional behavior of a viewer, such as an image of a viewer 160 cringing or covering his face. In response, the viewer's emotional response profile for that video item may indicate that the viewer was scared at that time during the item. The image data may also include subconscious displays of human emotional states. In such a scenario, image data may show that a user was looking away from the display at a particular time during a video item. In response, the viewer's emotional response profile for that video item may indicate that she was bored or distracted at that time. Eye-tracking, facial posture characterization and other suitable techniques may also be employed to gauge a viewer's degree of emotional stimulation and engagement with video item 150.

In some embodiments, an image sensor may collect light within a spectral region that is diagnostic of human physiological conditions. For example, infrared light may be used to approximate blood oxygen levels and/or heart rate levels within the body. In turn, such levels may be used to estimate the person's emotional stimulation.

Further, in some embodiments, sensors that reside in other devices than viewing environment sensor system 106 may be used to provide input to media computing device 104. For example, in some embodiments, an accelerometer included in a mobile computing device (e.g., mobile phones and laptop and tablet computers) held by a viewer 160 within video viewing environment 100 may detect gesture-based emotional expressions for that viewer.

FIGS. 1-3 schematically illustrate, at three successive times, different video items selected in response to detected changes in viewing audience constituency and/emotional responses of one or more viewers. In FIG. 1, viewers 160 and 162 are shown watching an action film. During this time, video viewing environment sensor system 106 provides sensor data captured from video viewing environment 100 to media computing device 104.

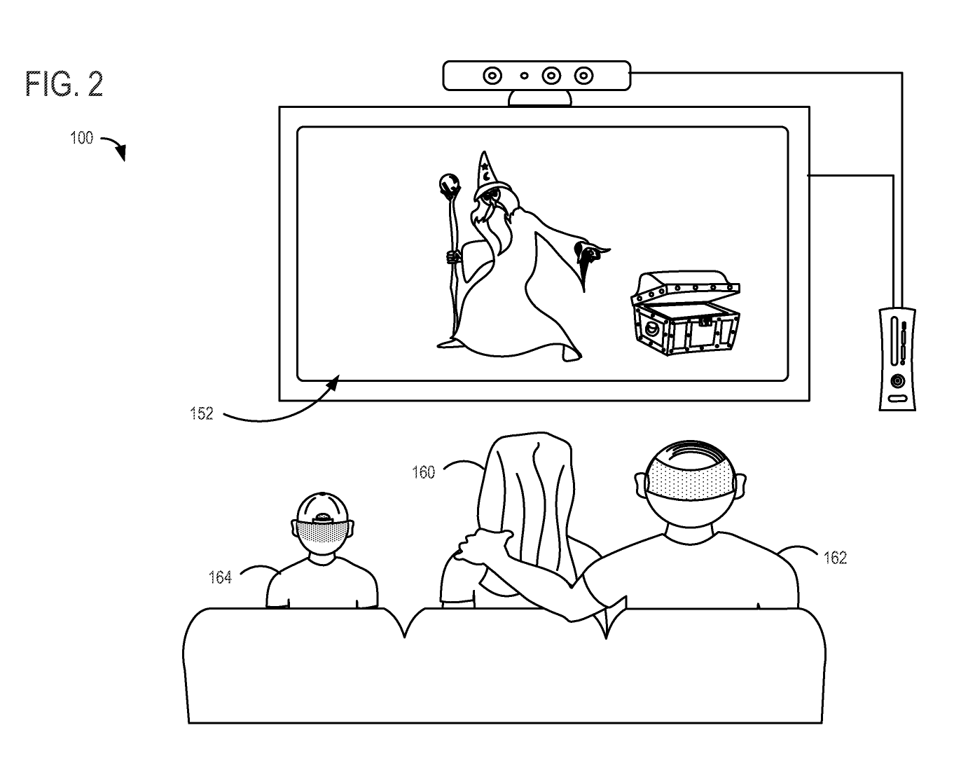

Next, in FIG. 2, media computing device 104 has detected the presence of viewer 164, for whom the action film may be too intense. Media computing device identifies viewer 164, obtains another video item, shown at 152 in FIG. 2, based upon a correlation with viewing interest profiles of viewers 160, 162 and 164, and outputs it to display device 102.

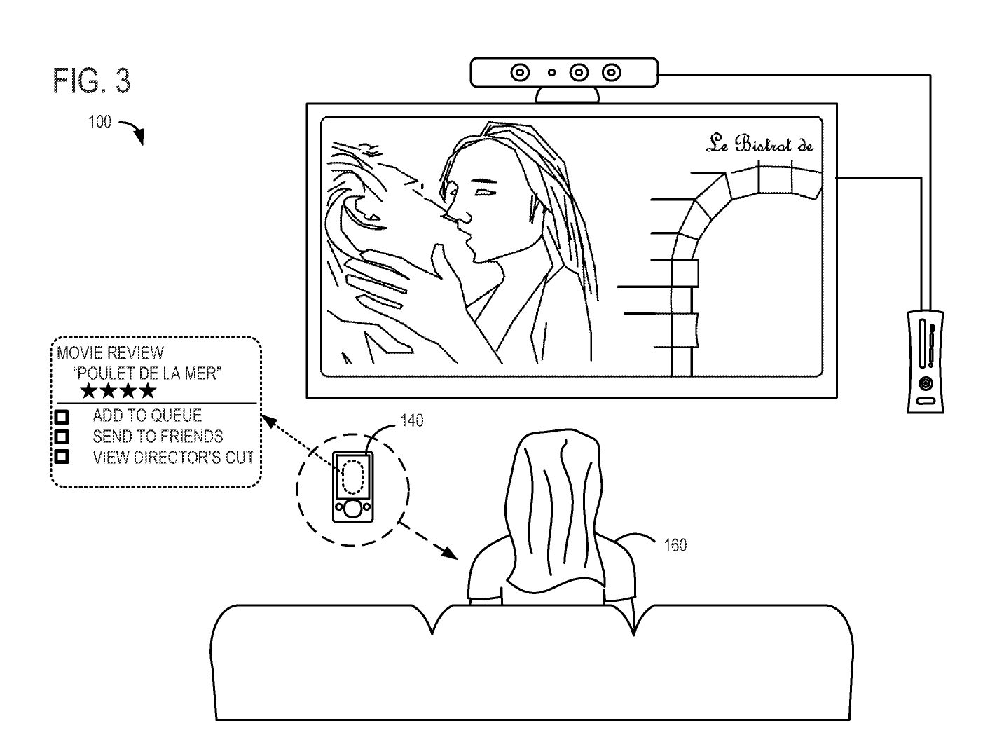

Next, in FIG. 3, viewers 162 and 164 have departed video viewing environment 100. Determining that viewer 160 is alone in viewing environment 100, media computing device 104 obtains video item 154 based on a correlation with the interests of viewer 160 alone. As this scenario illustrates, updating the video item according to the constituency (and interests) of viewers watching display device 102 within video viewing environment 100 may provide an enhanced viewing experience and facilitate the discovery of content for an audience with mixed interests. In turn, viewers may be comparatively less likely to change channels, and therefore potentially more likely to view advertisements relative to traditional open-loop broadcast television.

The brief scenario described above relates to the selection of video items 150 based on the respective identities and emotional profiles of viewers 160. Further, in some embodiments, real-time emotional response data may be used to update a video content item currently being viewed. For example, based upon real-time emotional responses to a video item, a version of the item being displayed (e.g., content-edited vs. unedited) may be changed. As a more specific example, if media computer 104 detects that a viewer 160 is embarrassed by strong language in video item 150, media computing device 104 may obtain an updated version having strong language edited out. In another example, if video viewing environment sensor system 106 detects viewer 160 asking viewer 162 what a character in video item 150 just said, media computing device 104 may interpret the question as a request that a related portion of video item 150 be replayed, and replay that portion in response to that request.

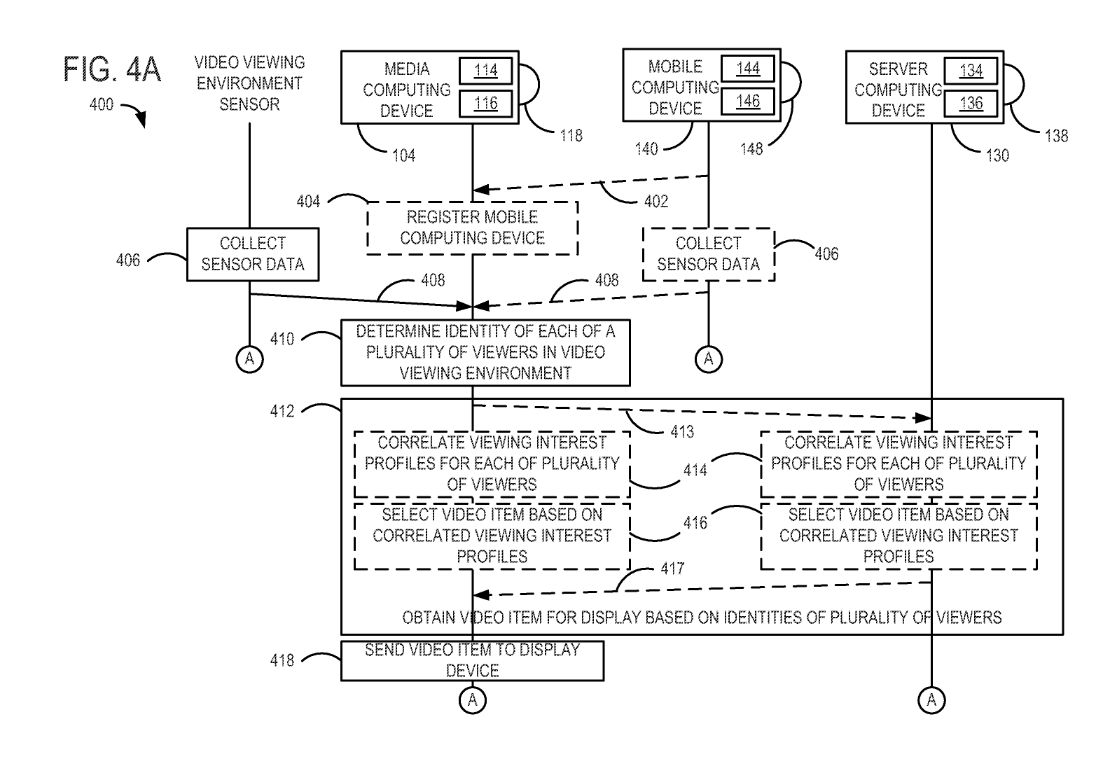

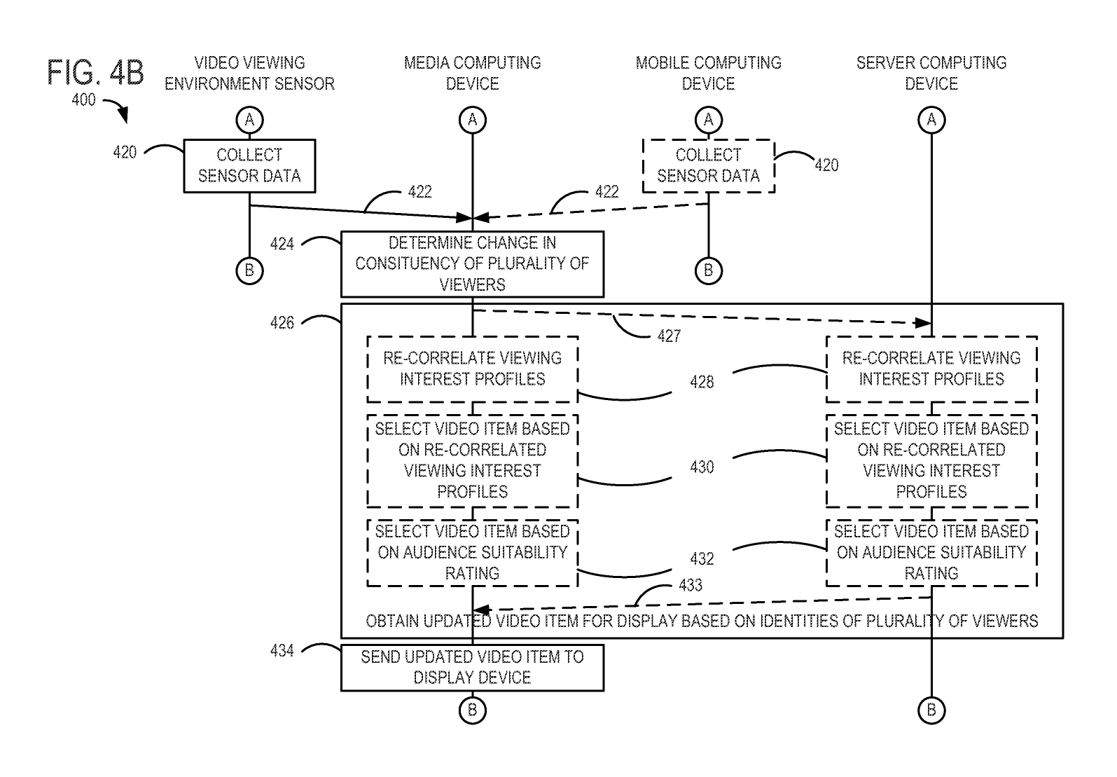

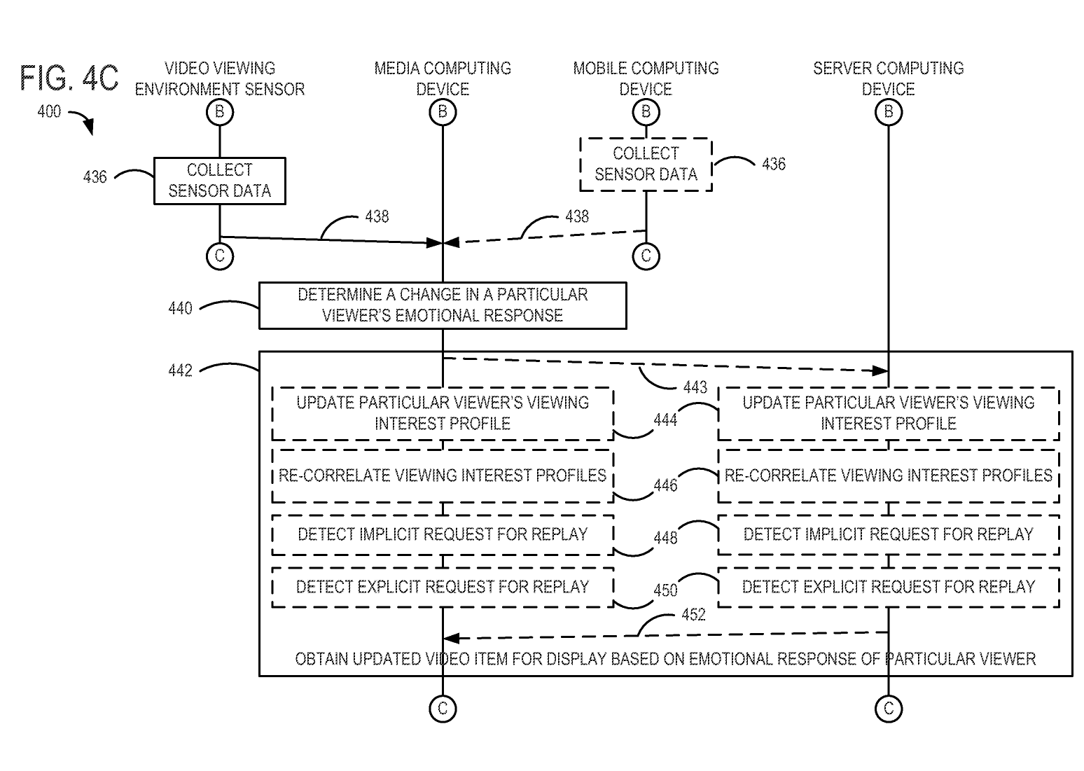

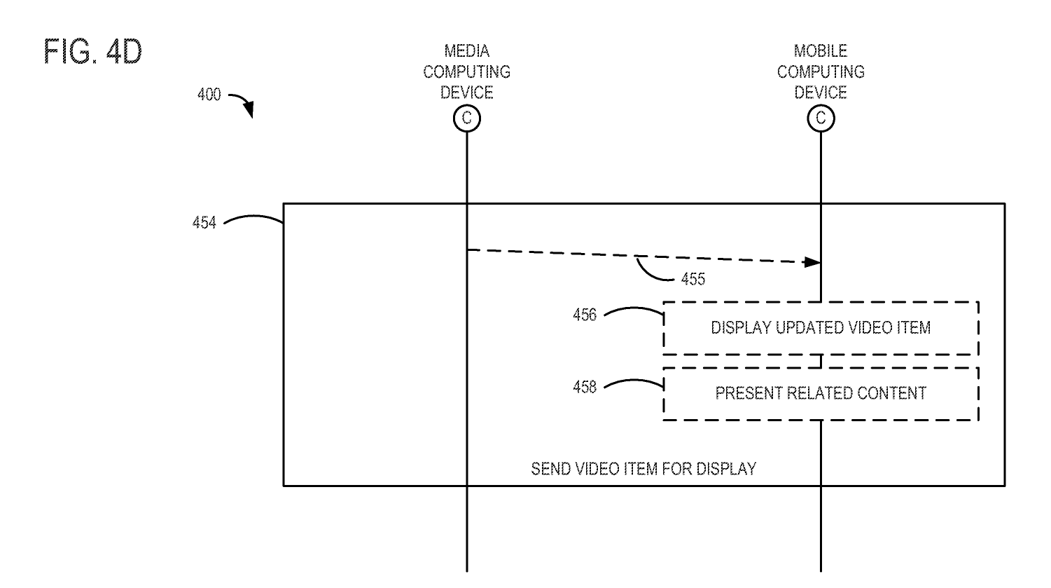

FIGS. 4A-D show a flow diagram depicting an embodiment of a method 400 of providing video items to viewers in a video viewing environment. It will be appreciated that method 400 may be performed by any suitable hardware, including but not limited to the embodiments depicted in FIGS. 1-3 and elsewhere within this disclosure. As shown in FIG. 4A, media computing device 104 includes a data-holding subsystem 114, and a logic subsystem 116, wherein data-holding subsystem 114 may hold instructions executable by logic subsystem 116 to perform various processes of method 400. Such instructions also may be held on removable storage medium 118. Similarly, the embodiments of server computing device 130 and mobile computing device 140 shown in FIG. 4A each include data-holding subsystems 134 and 144 and logic subsystems 136 and 146, and also may include or otherwise be configured to read and/or write to removable computer storage media 138 and 148, respectively. Aspects of such data-holding subsystems, logic subsystems, and computer storage media are described in more detail below.

As mentioned above, in some embodiments, sensor data from sensors on a viewer's mobile device may be provided to the media computing device. Further, supplemental content related to a video item being watched on a primary viewing environment display may be provided to the viewer's mobile device. Suitable mobile computing devices include, but are not limited to, mobile phones and portable personal computing devices (e.g., laptops, tablet, and other such computing devices). Thus, in some embodiments, method 400 may include, at 402, sending a request from a mobile computing device belonging to a viewer in the video viewing environment to the media computing device to register the mobile computing device with the media computing device, and at 404, registering the mobile computing device. In some of such embodiments, the mobile computing device may be registered with a viewer's personal profile.

At 406, method 400 includes collecting sensor data from video viewing environment sensor system 106 and potentially from mobile device 140, and at 408, sending the sensor data to the media computing device, which receives the input of sensor data. Any suitable sensor data may be collected, including but not limited to image data, depth data, acoustic data, and/or biometric data.

At 410, method 400 includes determining an identity of each of the plurality of viewers in the video viewing environment from the input of sensor data. In some embodiments, a viewer's identity may be established from a comparison of image data collected by the sensor data with image data stored in a viewer's personal profile. For example, a facial similarity comparison between a face included in image data collected from the video viewing environment and an image stored in a viewer's profile may be used to establish the identity of that viewer. In this example, the viewer may not use a password to log in. Instead, the media computing device may detect the viewer, check for the existence of a profile for the viewer, and, if a profile exists, confirm the identity of the viewer. A viewers' identity also may be determined from acoustic data, and/or any other suitable data.

At 412, method 400 includes obtaining a video item for display based upon the identities of the plurality of viewers in the video viewing environment. It will be appreciated that aspects of 412 may occur at the media computing device and/or at a server computing device at various embodiments. Thus, aspects that may occur on either device are shown in FIG. 4A as sharing a common reference number, though it will be appreciated that the location where the process may be performed may vary. Thus, in embodiments where aspects of 412 are performed at a server computing device, 412 includes, at 413, sending determined identities for the plurality of viewers to a server, and, at 417, receiving the video item from the server. In embodiments in which aspects of 412 are performed at a media computing device, processes 413 and 417 may be omitted.

Obtaining the video item may comprise, at 414, correlating viewing interest profiles stored for each of the plurality of viewers with one another and with information about available video items, and then, at 416, selecting the video item based on the correlation. For example, in some embodiments, the video item may be selected based on an intersection of the viewing interest profiles for the viewers in the video viewing environment, as described in more detail below.

A viewing interest profile catalogs a viewer's likes and dislikes for video media, as judged from the viewer's emotional responses to past media experiences. Viewing interest profiles are generated from a plurality of emotional response profiles, each emotional response profile temporally correlating the viewer's emotional response to a video item previously viewed by the viewer. Put another way, the viewer's emotional response profile for a particular video item organizes that viewer's emotional expressions and behavioral displays as a function of a time position within that video item. As the viewer watches more video items, the viewer's viewing interest profile may be altered to reflect changing tastes and interests of the viewer as expressed in the viewer's emotional responses to recently viewed video items.

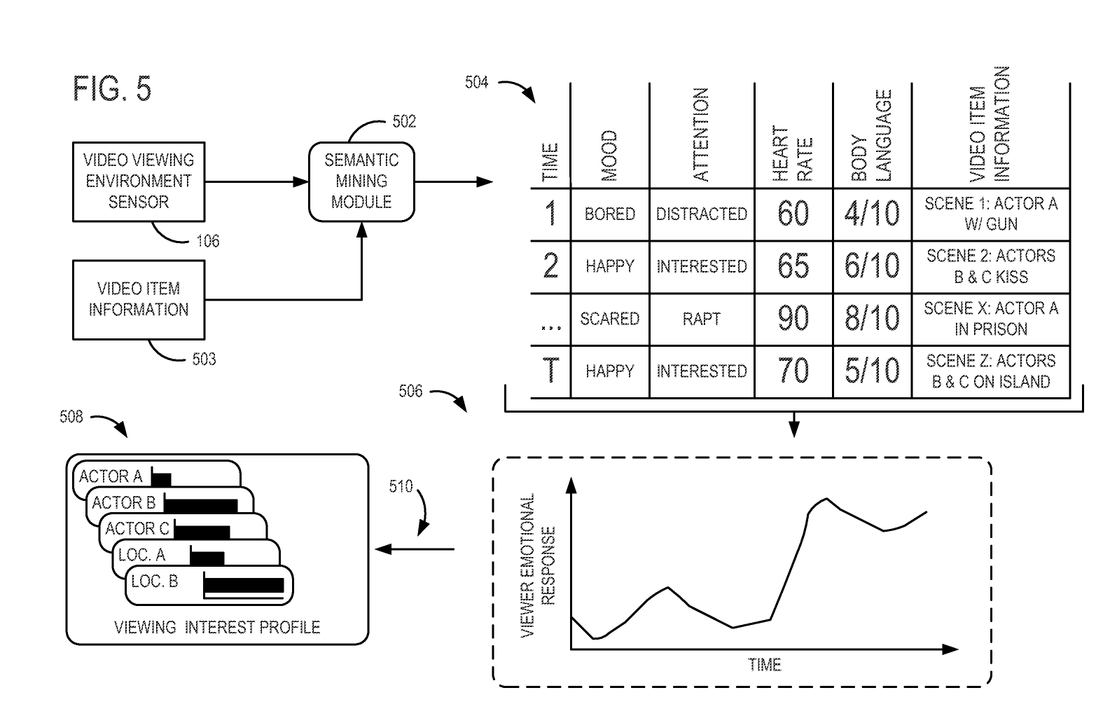

FIG. 5 schematically shows embodiments of a viewer emotional response profile 504 and a viewing interest profile 508. As shown in FIG. 5, viewer emotional response profile 504 is generated by a semantic mining module 502 running on one or more of media computing device 104 and server computing device 130 using sensor information received from one or more video viewing environment sensors. Using emotional response data from the sensor and also video item information 503 (e.g., metadata identifying particular video item the viewer was watching when the emotional response data was collected and where in the video item the emotional response occurred), semantic mining module 502 generates viewer emotional response profile 504, which captures the viewer's emotional response as a function the time position within the video item.

In the example shown in FIG. 5, semantic mining module 502 assigns emotional identifications to various behavioral and other expression data (e.g., physiological data) detected by the video viewing environment sensors. Semantic mining module 502 also indexes the viewer's emotional expression according to a time sequence synchronized with the video item, for example, by time of various events, scenes, and actions occurring within the video item. Thus, in the example shown in FIG. 5, at time index 1 of a video item, semantic mining module 502 records that the viewer was bored and distracted based on physiological data (e.g., heart rate data) and human affect display data (e.g., a body language score). At later time index 2, viewer emotional response profile 504 indicates that the viewer was happy and interested in the video item, while at time index 3 the viewer was scared but her attention was raptly focused on the video item.

In some embodiments, semantic mining module 502 may be configured to distinguish between the viewer's emotional response to a video item and the viewer's general temper. For example, in some embodiments, semantic mining module 502 may ignore, or may report that the viewer is distracted during, those human affective displays detected when the viewer's attention is not focused on the display device. Thus, as an example scenario, if the viewer is visibly annoyed because of a loud noise originating external to the video viewing environment, semantic mining module 502 may be configured not to ascribe the detected annoyance with the video item, and may not record the annoyance at that temporal position within the viewer's emotional response profile for the video item. In embodiments in which an image sensor is included as a video viewing environment sensor, suitable eye tracking and/or face position tracking techniques may be employed (potentially in combination with a depth map of the video viewing environment) to determine a degree to which the viewer's attention is focused on the display device and/or the video item.

FIG. 5 also shows viewer's emotional response profile 504 for a video item represented graphically at 506. While viewer emotional response profile 506 is presented as a single-variable time correlation, it will be appreciated that a plurality of variables representing the viewer's emotional response may be tracked as a function of time.

A viewer's emotional response profile 504 for a video item may be analyzed to determine the types of scenes/objects/occurrences that evoked positive and negative responses in the viewer. For example, in the example shown in FIG. 5, video item information, including scene descriptions, are correlated with sensor data and the viewer's emotional responses. The results of such analysis may then be collected in a viewing interest profile 508. By performing such analysis for other content items viewed by the viewer, as shown at 510, and then determining similarities between portions of different content items that evoked similar emotional responses, potential likes and dislikes of a viewer may be determined and then used to locate content suggestions for future viewing. For example, FIG. 5 shows that the viewer prefers actor B to actors A and C and prefers location type B over location type A. Further, such analyses may be performed for each of a plurality of viewers in the viewing environment. In turn, the results of those analyses may be aggregated across all present viewers and used to identify video items for viewing by the viewing party.

In some embodiments, additional filters may be applied (e.g., age-based filters that take into account the ages of members of the present viewers, etc.) to further filter content for presentation. For example, in one scenario, a video program may switch from a version that may include content not suitable for viewers of all ages to an all-ages version in response to a child (or another person with a viewing interest profile so-configured) entering the video viewing environment. In this scenario, the transition may be managed in an apparently seamless transition, so that a gap in programming does not result. In another scenario, a suitable display (for example, a 3D display paired with 3D glasses, or an optical wedge-based directional video display in which collimated light is sequentially directed at different viewers in synchronization with the production of different images via a spatial light modulator) may be used to deliver viewer-specific versions of a video item according to individual viewing preferences. Thus, a child may view an all-ages version of the video item and be presented with advertisements suitable for child audiences while an adult concurrently views a more mature version of the video item, along with advertisements geared toward an adult demographic group.

Turning back to FIG. 4A, in some embodiments, 412 includes, at 416, selecting the video item based on a correlation of viewing interest profiles for each of the plurality of viewers. In some embodiments, users may select to filter the data used for such a correlation, while such correlation may be performed without user input in other embodiments. For example, in some embodiments, the correlation may occur by weighting the viewing interest profiles of viewers in the video viewing environment so that a majority of viewers may be likely to be pleased with the result.

As a more specific example, in some embodiments, the correlation may be related to a video item genre that the viewers would like to watch. For example, if the viewers would like to watch a scary movie, the viewing interest profiles may be correlated based on past video item scenes that the viewers have experienced as being scary. Additionally or alternatively, in some embodiments, the correlation may be based on other suitable factors such as video item type (e.g., cartoon vs. live action, full-length movie vs. video clip, etc.). Once the video item has been selected, method 400 includes, at 418, sending the video item for display.

As explained above, in some embodiments, similar methods of selecting video content may be used to update a video item being viewed by a viewing party when a viewer leaves or joins the viewing party. Turning to FIG. 4B, method 400 includes, at 420, collecting additional sensor data from one or more video viewing environment sensors, and, at 422, sending the sensor data to the media computing device, where it is received.

At 424, method 400 includes determining from the additional sensor data a change in constituency of the plurality of viewers in the viewing environment. As a more specific example, the media computing device determines whether a new viewer has entered the viewing party or whether an existing viewer has left the viewing party, so that the video item being displayed may be updated to be comparatively more desirable to the changed viewing party relative to the original viewing party.

In some embodiments, a viewer may be determined to have exited the viewing party without physically leaving the video viewing environment. For example, if it is determined that a particular viewer is not paying attention to the video item, then the viewer may be considered to have constructively left the viewing party. Thus, in one scenario, a viewer who intermittently pays attention to the video item (e.g., directs her attention to the display for less than a preselected time before diverting her gaze again) may be present in the video viewing environment without having her viewing interest profile correlated. However, the media computing device and/or the semantic mining module may note those portions of the video item that grabbed her attention, and may update her viewing interest profile accordingly.

At 426, method 400 includes obtaining updated video item based on the identities of the plurality of viewers after the change in constituency is determined. As explained above, aspects of 426 may be performed at the media computing device and/or at the server computing device. Thus, in embodiments where aspects of 426 are performed at a server computing device, 426 includes, at 427, sending determined identities for the plurality of viewers to a server, the identities reflecting the change in constituency, and, at 433, receiving the updated video item from the server. In embodiments in which aspects of 426 are performed at a media computing device, processes 427 and 433 may be omitted.

In some embodiments, 426 may include, at 428, re-correlating the viewing interest profiles for the plurality of viewers, and, at 430, selecting the updated video item based on the re-correlation of the viewing interest profiles after the change in constituency. In such embodiments, the re-correlated viewing interest profiles may be used to select items that may appeal to the combined viewing interests of the new viewing party, as explained above. Once the video item has been selected, method 400 includes, at 434, sending the video item for display.

In some embodiments, the selected updated video item maybe a different version of the video item than that was being presented when the viewing party constituency changed. For example, the updated video item may be a version edited to display appropriate subtitles according to a language suitability of a viewer joining the viewing party. In another example, the updated video item may be a version edited to omit strong language and/or violent scenes according to a content suitability (for example, if a younger viewer has joined the viewing party). Thus, in some embodiments, 426 may include, at 432, updating the video item according to an audience suitability rating associated with the video item and the identities of the plurality of viewers. Such suitability ratings may be configured by individual viewers and/or by content creators, which may provide a way of tuning content selection to the viewer.

In some embodiments, the selected updated video item may be a different video item from the video item being presented when the viewing party constituency changed. In such embodiments, the viewers may be presented with an option of approving the updated video item for viewing and/or may be presented with a plurality of updated video items from which to choose, the plurality of updated video items being selected based on a re-correlation of viewing interest profiles and/or audience suitability ratings.

It will be appreciated that changes and updates to the video item being obtained for display may be triggered by other suitable events and are not limited to being triggered by changes in viewing party constituency. In some embodiments, updated video items may be selected based a change in the emotional status of a viewer in response to the video item being viewed. For example, if a video item is perceived by the viewers as being unengaging, a different video item may be selected. Thus, turning to FIG. 4C, method 400 includes, at 436, collecting viewing environment sensor data, and, at 438, sending the sensor data to the media computing device, where it is received.

At 440, method 400 includes determining a change in a particular viewer's emotional response to the video item using the sensor data. For example, in some embodiments where the video viewing environment sensor includes an image sensor, determining a change in a particular viewer's emotional response to the video item may be based on image data of the particular viewer's emotional response. Likewise, changes in emotional response also may be detected via sound data, biometric data, etc. Additionally or alternatively, in some embodiments, a change in the particular viewer's emotional response may include receiving emotional response data from a sensor included in the viewer's mobile computing device.

At 442, method 400 includes obtaining an updated video item for display based on a real-time emotional response of the particular viewer. As explained above, aspects of 442 may be performed at the media computing device and/or at the server computing device. Thus, in embodiments where aspects of 442 are performed at a server computing device, 442 includes, at 443, sending determined identities for the plurality of viewers to a server, the identities reflecting the change in constituency, and, at 452, receiving the updated video item from the server. In embodiments in which aspects of 442 are performed at a media computing device, processes 443 and 452 may be omitted.

In some embodiments, 442 may include, at 444, updating the particular viewer's viewing interest profile with the particular viewer's emotional response to the video item. Updating the viewer's viewing interest profile may keep that viewer's viewing interest profile current, reflecting changes in the viewer's viewing interests over time and in different viewing situations. In turn, the updated viewing interest profile may be used to select potentially more desirable video items for that viewer in the future.

In some embodiments, 442 may include, at 446, re-correlating the viewing interest profiles for the plurality of the viewers after updating the particular viewer's viewing interest profile and/or after detecting the change in the particular viewer's emotional response. Thus, if the viewer had an adverse emotional reaction toward the video item, re-correlation of the viewing interest profiles may lead to an update of the video item being display. For example, a different video item or a different version of the present video item may be selected and obtained for display.

In some embodiments, 442 may include, at 448, detecting an input of an implicit request for a replay of a portion of the video item, and, in response, selecting that portion of the video item to be replayed. For example, it may be determined that the viewer's emotional response included affect displays corresponding to confusion. Such responses may be deemed an implicit request to replay a portion of the video item (such as a portion being presented when the response was detected), and the user may be presented with the option of viewing the scene again. Additionally or alternatively, detection of such implicit requests may be contextually-based. For example, a detected emotional response may vary from a predicted emotional response by more than a preselected tolerance (as predicted by aggregated emotional response profiles for the video item from a sample audience, for example), suggesting that the viewer did not understand the content of the video item. In such cases, a related portion of the video item may be selected to be replayed.

It will be understood that explicit requests for replay may be handled similarly. Explicit requests may include viewer-issued commands for replay (e.g., “play that back!”) as well as viewer-issued comments expressing a desire that a portion be replayed (e.g., “what did she say?”). Thus, in some embodiments, 450 may include, at 444, detecting an input of an explicit request for a replay of a portion of the video item, and, in response, selecting that portion of the video item to be replayed.

Turning to FIG. 4D, once an updated video item has been obtained, method 400 includes, at 454, sending the updated video item for display. As explained above, some viewers may watch video items on a primary display (such as a television or other display connected with the media computing device) while choosing to receive primary and/or supplemental content on a mobile computing device. Thus, 454 may include, at 455, sending a video item (as sent initially or as updated) to a suitable mobile computing device for display, and at 456, displaying the updated video item.

In some embodiments, as indicated at 458, updated video items selected based on a particular viewer's viewing interest profile may be presented to that viewer on the mobile computing device for the particular viewer. This may provide personalized delivery of finely-tuned content for a viewer without disrupting the viewing party's entertainment experience. It may also provide an approach for keeping viewers with marginal interest levels engaged with the video item. For example, a viewer may watch a movie with a viewing party on the primary display device while viewing subtitles for the movie on the viewer's personal mobile computing device and/or while listening to a different audio track for the movie via headphones connected to the mobile computing device. In another example, one viewer may be presented with supplemental content related to a favorite actor appearing in the video item via his mobile computing device as selected based on his emotional response to the actor. Concurrently, a different viewer may be presented with supplemental content related to a filming location for the video item on her mobile display device, the content being selected based on her emotional response to the a particular scene in the video item. In this way, the viewing party may continue to enjoy, as a group, a video item selected based on correlation of their viewing interest profiles, but may also receive supplemental content selected to help them, as individuals, get more enjoyment out of the experience.

As introduced above, in some embodiments, the methods and processes described in this disclosure may be tied to a computing system including one or more computers. In particular, the methods and processes described herein may be implemented as a computer application, computer service, computer API, computer library, and/or other computer program product.

FIG. 4A schematically shows, in simplified form, a non-limiting computing system that may perform one or more of the above described methods and processes. It is to be understood that virtually any computer architecture may be used without departing from the scope of this disclosure. In different embodiments, the computing system may take the form of a mainframe computer, server computer, desktop computer, laptop computer, tablet computer, home entertainment computer, network computing device, mobile computing device, mobile communication device, gaming device, etc.

The computing system includes a logic subsystem (for example, logic subsystem 116 of mobile computing device 104 of FIG. 4A, logic subsystem 146 of mobile computing device 140 of FIG. 4A, and logic subsystem 136 of server computing device 130 of FIG. 4A) and a data-holding subsystem (for example, data-holding subsystem 114 of mobile computing device 104 of FIG. 4A, data-holding subsystem 144 of mobile computing device 140 of FIG. 4A, and data-holding subsystem 134 of server computing device 130 of FIG. 4A). The computing system may optionally include a display subsystem, communication subsystem, and/or other components not shown in FIG. 4A. The computing system may also optionally include user input devices such as keyboards, mice, game controllers, cameras, microphones, and/or touch screens, for example.

The logic subsystem may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

The data-holding subsystem may include one or more physical, non-transitory, devices configured to hold data and/or instructions executable by the logic subsystem to implement the herein described methods and processes. When such methods and processes are implemented, the state of the data-holding subsystem may be transformed (e.g., to hold different data).

The data-holding subsystem may include removable media and/or built-in devices. The data-holding subsystem may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. The data-holding subsystem may include devices with one or more of the following characteristics: volatile, nonvolatile, dynamic, static, read/write, read-only, random access, sequential access, location addressable, file addressable, and content addressable. In some embodiments, the logic subsystem and the data-holding subsystem may be integrated into one or more common devices, such as an application specific integrated circuit or a system on a chip.

FIG. 4A also shows an aspect of the data-holding subsystem in the form of removable computer storage media (for example, removable computer storage media 118 of mobile computing device 104 of FIG. 4A, removable computer storage media 148 of mobile computing device 140 of FIG. 4A, and removable computer storage media 138 of server computing device 130 of FIG. 4A), which may be used to store and/or transfer data and/or instructions executable to implement the herein described methods and processes. Removable computer storage media may take the form of CDs, DVDs, HD-DVDs, Blu-Ray Discs, EEPROMs, and/or floppy disks, among others.

It is to be appreciated that the data-holding subsystem includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of the computing system that is implemented to perform one or more particular functions. In some cases, such a module, program, or engine may be instantiated via the logic subsystem executing instructions held by the data-holding subsystem. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, a display subsystem may be used to present a visual representation of data held by the data-holding subsystem. As the herein described methods and processes change the data held by the data-holding subsystem, and thus transform the state of the data-holding subsystem, the state of display subsystem may likewise be transformed to visually represent changes in the underlying data. The display subsystem may include one or more display devices utilizing virtually any type of technology. Such display devices may be combined with the logic subsystem and/or the data-holding subsystem in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. At a media presentation computing device, a method for providing video items to a plurality of viewers in a video viewing environment, the method comprising:
receiving at the media computing device an input of sensor data from one or more video viewing environment sensors;
determining an identity of each of the plurality of viewers in the video viewing environment from the input of sensor data;
obtaining a video item for display based upon the identities of the plurality of viewers in the video viewing environment; and
sending the video item for display.

2. The method of claim 1, wherein obtaining the video item comprises:
sending determined identities for the plurality of viewers to a server; and
receiving the video item from the server, the video item selected based on a correlation of viewing interest profiles for each of the plurality of viewers, each viewing interest profile generated from a plurality of emotional response profiles, each emotional response profile representing a temporal correlation of a particular viewer's emotional response to a media item previously viewed by the particular viewer.

3. The method of claim 1, wherein obtaining the video item comprises correlating viewing interest profiles for each of the plurality of viewers, each viewing interest profile generated from a plurality of emotional response profiles, each emotional response profile representing a temporal correlation of a particular viewer's emotional response to a media item previously viewed by the particular viewer and selecting the video item based upon correlated viewing interest profiles.

4. The method of claim 1, further comprising:
determining a change in constituency of the plurality of viewers;
obtaining an updated video item, the updated video item selected based on a re-correlation of the viewing interest profiles for the plurality of the viewers after the change in constituency; and
sending the updated video item for display after receiving the updated video item.

5. The method of claim 4, wherein obtaining the updated video item includes updating the video item according to an audience suitability rating associated with the video item and the identities of the plurality of viewers.

6. The method of claim 1, further comprising:
determining a change in the particular viewer's emotional response to the video item;
obtaining updated video item, the updated video item selected based on a re-correlation of the viewing interest profiles for the plurality of the viewers after determining the change in the particular viewer's emotional response to the video item; and
sending the updated video item for display after receiving the updated video item.

7. The method of claim 6, further comprising updating the particular viewer's viewing interest profile with the particular viewer's emotional response to the video item.

8. The method of claim 6, further comprising detecting an input of an implicit request for a replay of the video item, and, in response to the input, replaying a segment of the video item.

9. The method of claim 6, further comprising detecting an input of an explicit request for a replay of the video item, and, in response to the input, replaying a segment of the video item.

10. The method of claim 6, wherein the change in the particular viewer's emotional response includes an adverse emotional reaction toward the video item, and wherein updating the video item includes selecting different video item for display.

11. A media presentation system, comprising:
a peripheral input configured to receive image data from a depth camera;
a display output configured to output video content to a display device;
a logic subsystem operatively connectable with the depth camera via the peripheral input and with the display device via the display output; and
a data-holding subsystem holding instructions executable by the logic subsystem to:
receive an input of image data for a video viewing environment from the peripheral input,
determine an identity of each of a plurality of viewers in the video viewing environment from the input of image data,
obtain a video item for display based upon the identities of the plurality of viewers in the video viewing environment,
output the video item for display on the display device,
determine a change in constituency of the plurality of viewers,
obtain an updated video item, the updated video item selected based upon the identities of the plurality of viewers after the change in constituency, and
output the updated video item for display on the display device.

12. The system of claim 11, wherein obtaining the video item comprises sending determined identities to a server and receiving the video item from the server, the video item selected based upon a correlation of viewing interest profiles for each of the plurality of viewers, each viewing interest profile generated from a plurality of emotional response profiles, each emotional response profile representing a temporal correlation of a particular viewer's emotional response to a media item previously viewed by the particular viewer, and
wherein obtaining the updated video item comprises sending determined identities for the plurality of viewers after the change in constituency to the server and receiving the updated video item from the server, the updated video item selected based on a re-correlation of the viewing interest profiles for the plurality of viewers after the change in constituency.

13. The system of claim 11, wherein obtaining the video item comprises correlating viewing interest profiles for each of the plurality of viewers, each viewing interest profile generated from a plurality of emotional response profiles, each emotional response profile representing a temporal correlation of a particular viewer's emotional response to a media item previously viewed by the particular viewer, and selecting the video item based upon correlated viewing interest profiles, and
wherein obtaining the updated video item comprises re-correlating the viewing interest profiles for the plurality of viewers after the change in constituency and selecting the updated video item based upon re-correlated viewing interest profiles.

14. The system of claim 11, further comprising determining a change in a particular viewer's emotional response to the video item based on image data of the particular viewer's emotional response received from the peripheral input, wherein obtaining updated video content comprises selecting the updated video item based upon the image data of the particular viewer's emotional response to the video item.

15. The system of claim 14, further comprising presenting content related to the video item on a mobile computing device for the particular viewer, and wherein determining a change in the particular viewer's emotional response includes receiving emotional response data from a sensor included in the mobile computing device.

16. The system of claim 15, wherein the mobile computing device is one of a mobile phone, a personal computing device, and a tablet computing device.

17. At a media presentation computing device, a method for providing a video item to a plurality of viewers in a video viewing environment, the method comprising:
receiving, at the media computing device, an input of sensor data from one or more video viewing environment sensors;
determining an identity of each of the plurality of viewers in the video viewing environment from the input of sensor data;
sending determined identities for the plurality of viewers to a server;
receiving the video item from the server, the video item selected based on a correlation of viewing interest profiles for each of the plurality of viewers, each viewing interest profile generated from a plurality of emotional response profiles, each emotional response profile representing a temporal correlation of a particular viewer's emotional response to a media item previously viewed by the particular viewer;
sending the video item for display; and
sending related content to a mobile computing device belonging to a particular viewer of the plurality of viewers.

18. The method of claim 17, further comprising detecting an input of an implicit or an explicit request for a replay of the video item from the particular viewer, and, in response to the input, replaying a segment of the video item on the mobile computing device.

19. The method of claim 17, further comprising detecting an adverse emotional reaction by the particular viewer to the related content, and, in response, selecting an updated video item for display on the mobile computing device.

20. The method of claim 17, further comprising:
determining a change in constituency for the plurality of viewers;
sending determined identities for the plurality of viewers after the change in constituency to the server;
receiving an updated video item from the server, the updated video item selected based on a re-correlation of the viewing interest profiles for the plurality of viewers after the change in constituency; and
sending the updated video item to a display device for display.
